(19) United States
(12) Patent Application Publication
(10) Pub. No.: US 2017/0365005 A1
(43) Pub. Date: Dec. 21, 2017

(54) Evidence for private company valuation

(71) Applicant: Dustan Bonnin, Belmont, MA (US)

(72) Inventor: Dustan Bonnin, Belmont, MA (US)

(73) Assignee: Catapult Intelligence, LLC, Cambridge, MA (US)

(21) Appl. No.: 15/731,471

(22) Filed: Jun. 14, 2017

Related U.S. Application Data
(60) Provisional application No. 62/392,908, filed on Jun. 14, 2016.

(51) Int. Cl. G06Q 40/04; G06F 17/30

(52) U.S. Cl. CPC G06Q 40/04; G06F 17/30979

(57) ABSTRACT

The instant invention discloses the creation, storage and use of new types of data enabled by the use of the technology of information to facilitate and capture contributions to decision-making efforts by non-professionals that augment results generated by professionals alone, where the use of such data is purposed for the generation of reliable and relevant evidence in the valuation of privately held small businesses in the context of transactions, litigation, regulation, and tax.

### CROSS-REFERENCE TO RELATED APPLICATIONS

This application takes priority from provisional application 62/392,908 filed on Jun. 14, 2016.

### STATEMENT REGARDING FEDERALLY SPONSORED RESEARCH OR DEVELOPMENT

Not applicable.

### FIELD OF THE INVENTION

The instant invention pertains to the field of business valuation, in particular to the lack of relevant and reliable data in business valuation when the subject business is a closely held company.

### BACKGROUND OF THE INVENTION

### Evidence

The different stakeholders of a subject business have valid, and sometimes opposing, interests in valuing a business. The independence and impartiality of an uninterested third-party professional is paramount to obtaining a Conclusion of Value to which all stakeholders will agree. Historical facts are often considered more credible evidence than future projections of what one side thinks will happen. The judiciary has been instrumental in cementing this view. In Daubert et ux v Merrell Dow Pharmaceuticals, Inc. (509 U.S. 579 1992) the Supreme Court required federal trial judges to act as gatekeepers to “ensure that any and all scientific testimony or evidence admitted is not only relevant but reliable.” The Supreme Court in Kumho Tire Co. v Carmichael (526 U.S. 137 1999) later clarified that Daubert's requirements of relevance and reliability apply not only to scientific testimony but to all evidentiary testimony, including that from business valuation professionals. Regarding reliability, the Court stated that all relevant facts, including methodologies employed by the business valuation professionals, the facts and data relied upon by the business valuation professional, and said professional's application of the methodologies in view of the facts and data must be considered by the court. Reporting in this context typically expresses a conclusion of value, and may or may not include in-court testimony.

### Risk Measurements in Valuation

Risk has a significant impact on the value of a company. Some risks can be measured. For example, historical financial analysis can provide an estimation of a company's ability to consistently deliver benefits of ownership in the form of dividends, or distributions. For companies with no financial history, or where the valuator believes the value of the company is not borne out entirely using historical financial analysis, risk can be measured by looking at the variability in a company's ability to meet milestones, key performance indicators (KPI). While these methods work very well when valuing a public company that has a number of public bright line comparators available, comparing financials, milestones, and KPIs of a small, privately held business to public bright line comparators provides a far less accurate comparability. There remains a need for reliable private company information that is relevant for the valuation of a small private business for transactional, litigation, regulatory, or tax purposes.

### Solution

The instant invention solves the problem of the lack of reliable, relevant private company-derived evidence by a unique enlistment of the capabilities the technology of information to create, store and use new and useful types of data generated through industry participants making decisions in an investment context through via exemptions within Titles I-IV of the U.S. JOBSAct of 2012, and wherein said data generation is standardized and subsequently disseminated to stakeholders in the valuation of closely held businesses. The instant invention discloses the creation, storage and use of new types of data enabled by the use of the technology of information to facilitate and capture contributions to decision-making efforts by non-professionals that augment results generated by professionals alone, where the use of such data is purposed for the generation of reliable and relevant evidence in the valuation of privately held small businesses in the context of transactions, litigation, regulation, and tax (collectively defines: evidentiary data).

### BRIEF SUMMARY OF THE INVENTION

### Valuation

Accepted business valuation approaches and methods recognized by The American Society of Appraisers and Business Valuation Standards include the income approach, the market approach, and the asset approach. Within the market approach the business valuator will look for data on comparable businesses for guidance in determining applicable valuation parameters, including different ratios and metrics of financial liquidity, operational efficiency, operational profitability, and business & financial risk. When using these ratios to generate an estimation of value using the market approach the lack of relevance between private companies being valued and the available public comparables is a well-known problem of relevance. Reporting in valuation engagements can express a conclusion of value, or a calculation of value either written or orally.

The methods, data and uses of the instant invention create, store and use evidentiary data by deriving information from transactions in private companies that are only made possible both by changes in regulation (JOBSAct) that enable public transparency on investing activities, and by the capabilities of the technology of information to create private company information that is both reliable and relevant in the context of business valuation and asset appraisal for the purposes of transactions, litigation, regulation and tax.

### Digital

The technology of information is changing the way business is done. Capabilities include the enablement of the creation and transference of information in new, more efficient and more capable ways. Think Web 2.0. These capabilities have changed the way industry delivers information. Think of the state of map makers, travel agents, yellow pages, CD stores, and newspapers prior to the technology of information. Today we have Google Maps, Trip Advisor, Yelp, Apple Store, and a series of online news outlets. The technology of information changes the way an industry delivers its products (collectively defines: digital).

What about the incumbent expertise-based industries of higher education, healthcare or professional services in law or financial services? Incumbents in these industries still hold value in the marketplace; yet of these industries, those having a combination of monopoly cultures, lack of transparency, lack of access, a preponderance of middlemen, and high economic rents protected by regulation are still subject to digital, crowd-based disruptions in the way their services are delivered. Healthcare and financial services exhibit a number of these characteristics, and the sectors have been subject to rapid disruption in recent years.

Digital's capabilities allow for participants in an industry who historically do not contribute data to the industry (the crowd) to contribute their own data to the industry, this data heretofore having not existed. Incumbents, not the crowd, are dis-incentivized to incorporate the crowd's decision-making capabilities into their offerings, and incumbents do not maintain or exert control over any data the crowd creates as it reduces incumbents' influence over their industry.

### Crowd-Based Data

The instant invention defines two types of crowd-based data. In the first type, individuals in the crowd initiate data creation using their own knowledge and experience, without the guidance of the industry nor incumbents. This type data is provided to other members of the crowd, and the sum of the transferences of and conversations create data (collectively defines: crowd-as-expert data). Crowd-as-expert data is uncured, messy, and potentially unreliable in its native form. At some future point, if the crowd-as-expert data gains traction and is proven in some way, incumbents will attempt to add to the quality of the data by using their expertise and influence to eventually co-opt crowd-as-expert data. This is possible as the crowd that created the crowd-as-expert data is typically not organized formally and unwilling or unable to protect the data generated.

The second type of crowd-based data derives from the crowd's response to its participation in an industry-driven interaction. Without industry providing the interaction, this type of data would not exist. The industry controls and uses this type of data is for the benefit of the industry and is remunerated in the form of rent. Ultimately the crowd that provided the data in the form of a using a product or service also benefits. This scenario is sometime referred to as a triangular value chain. Because the data creation by the crowd is being guided by industry interactions this type of data is typically of high utility, and has a propensity not to be uncured, nor messy but to be reliable in its native form (collectively defines: crowd-as-participant data).

### Constraints on Creation of Crowd-Based Data

A problem arises when (i) the incumbents of an industry do not provide the crowd with an opportunity to create crowd-as-participant data because they feel the information created by incumbents and used by the industry is sufficient, and (ii) regulatory regimes designed to protect the crowd, while not expressly prohibiting the creation of crowd-based data, perversely constrain, deter, and diminish any incentives to create crowd-based data. The result is that (i) incumbents, having created an expert version of the data themselves, wish to obtain remuneration in the form of rent for access to their data (advice), and (ii) the crowd has no infrastructure built-up to create crowd-based data. Examples of industries where this occurs include healthcare and investing.

### Implications of Regulatory Change

With the passage of Titles I-IV of JOBSAct in 2012, and the promulgation of rules leading to the April 2016 activation of Title III, retail (non-accredited) investors were given the right to purchase a security issued by a private company. Given the discussion above, the retail investor, e.g. the crowd, was unprepared to handle the evaluation of the companies in which they could now invest. This legislation-driven regulatory change created a need for advice to this new customer class that incumbents were either not economically incentivized to provide (low-touch, high volume advice), or are prohibited from providing by regulation, for example Regulated Portals mediating Title III security issuances. Said new customer class is exemplified by, but not limited to, retail investors, where said retail investors desire, but are effectively unable to obtain, 3^{rd} Party-based information and/or education about a potential alternative investing investment in a private company, such companies typically residing at the stages of development as described in FIG. 1 (collectively defines: alternative investing).

The instant invention's methods, data and uses thereof are an improvement over the existing art, and are based on the real-world finding that using a collection of over thirty questions with ranged answers to evaluate alternative investing issuers for investment, an analysis of data created by crowd-based decisions were able to create a reliable risk classification scheme while an analysis of data created by experts failed to do so (Example 1).

### BRIEF SUMMARY OF THE DRAWINGS

FIG. 1 Small and emerging businesses (SMEs) as the scope of the use of the instant invention as described by development stage, company stage, funding stage, and company focus.

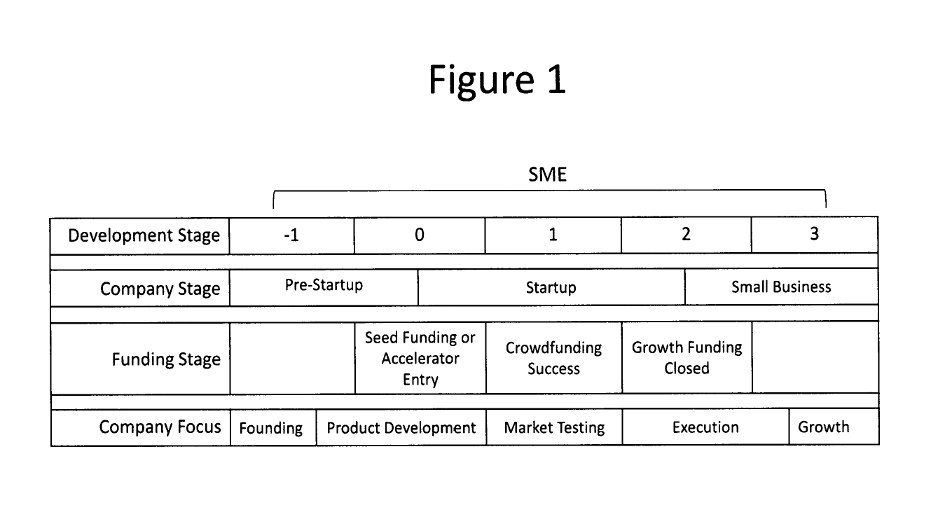

FIG. 2 Resolution of classification of alternative investing potential using expert scores (2A) and Crowd-as-participant scores (2B).

### DETAILED DESCRIPTION OF THE INVENTION

### Crowd-as-Expert

A new type of data has been created with digital's capabilities, defined here as crowd-as-expert data. A first example of crowd-as-expert data can be found in the context of healthcare, in particular rare diseases, were the data represents all of the understandings that incumbents (here, the scientific and medical communities, payors, regulators) do not have about a diagnosed family, the implications of their condition that manifest in the day-to-day reality of living with a rare disease. Generated by the patients and their caregivers themselves, crowd-as-expert data is about quality of life, it is environmental in nature and is characterized by the fact that because of the costs of the existing drug development regulatory regime no incumbent is going to spend large amounts of time and resources on an intervention that they can't monetize because the market is so very small. Digital, the technology of information, if used properly can help patients and caregivers turn this new data, crowd-as-expert data, into a form that is useable by incumbents in the creation of treatments and medicines. This is the transference of wisdom from ‘the crowd’ (in this example patients and their caregivers) to the professional services incumbents in a one-way interaction. This type of data generation is nascent and remains constrained.

In can be appreciated that the example above of crowd-as-expert data generated by the rare disease community coming together to create data that would otherwise not be created (due to existing cultural, legal, regulatory, financial, and rent-making constraints), is also relevant in industries where similar constraints have previously existed or currently exist. In the case of alternative investing, the generation of information on private companies potentially useful as evidentiary data have only become possible with changes in regulation represented by the JOBSAct of 2012, and the promulgation and activation of rules for Title III in 2016.

### Crowd-as-Participant Data not Seen Regulated Industries

Crowd-as-participant data in financial services can substantially only be generated via alternative investing. Alternative investing-derived Crowd-as-participant data represents the crowd's interaction with data public incumbents (mutual funds, investment banks) do not produce, or private incumbents (venture capital firms, hedge funds, broker-dealers, accredited investors) do not share, about small and emerging businesses (collectively defines: SME data). The collection of SME data defies the standard techniques that public incumbents use to analyze and report on public companies for use as guidance for retail investors for investment decisioning. This is in large part because while public companies are compelled by regulatory requirements to disclose anything that is important, or material, to the health of the business, private SMEs do not have these burdensome disclosure requirements, even now in the context of the new regulations under the JOBSAct.

The retail investing public has been subject to a fraud protection regime via the Securities Act of 1933. For over 80 years regulators have required that only investors having a surrogate for sophistication, for example high net worth or high income (accredited investors), be allowed to invest in private SMEs. A cottage industry has grown up around this regulation, where industry incumbents have developed sophisticated investment strategies acceptable to accredited investors. Intense competition exists between private incumbents for the relatively few number of accredited investors' relatively large pool of investment dollars. Because of this, their strategies remain largely private. Individual accredited investors have no incentive to share the information that they have paid for through advisory fees. Thus, information on private SMEs generally, and information useful in the generation of SME data is limited. This information asymmetry has been acceptable to these industry participants.

### Methods of Data Creation

Methods of the instant invention comprise the creation of data by industry participants. In an embodiment of the methods of the instant invention data is created by industry participants taking the following steps: (i) defining attributes about one or more alternative investing issuers where the attributes are exposed by questions that are selected from different segments of said issuer's business, (ii) further defining said attributes about one or more alternative investing issuers where the attributes are recorded by answers to said questions in Step 1, and (iii) determining said attributes of said one or more alternative investing issuers using techniques selected from the group comprising investment research by one or more industry participants, face to face interviews where answers are recorded on paper later transcribed into a digital medium and stored in one or more databases accessible by one or more computing devices, face to face interviews where answers are recorded in a digital medium and stored in or more databases accessible by one or more computing devices, remote interviews where answers are recorded on paper later transcribed into a digital medium and stored in one or more databases accessible by one or more computing devices, remote interviews where answers are recorded in a digital medium and stored in or more databases accessible by one or more computing devices, paper surveys where answers are recorded on paper later transcribed into a digital medium and stored in one or more databases accessible by one or more computing devices, and online surveys where answers are recorded in a digital medium and stored in or more databases accessible by one or more computing devices. In a further embodiment of the methods of the instant invention said answers of Step 2 above are in a format selected from the group comprising unstructured, structured, open-ended, semi-structured, and closed. In yet a further embodiment of the methods of the instant invention said answers of Step 2 above are comparable from one alternative investing issuer's answers to another. In yet a further embodiment of the methods of the instant invention said answers of Step 2 above are converted to a numerical format. In a preferred embodiment of the methods of the instant invention said answers of Step 2 above are tagged with one or more events in the life of said issuer of Step 1 above, said events selected from the group comprising reaching a goal, reaching a goal defined by said issuer, reaching a goal defined by an industry participant, stage in product development, implementation of best practices, adherence to best practices, first or next performance certification such as ISO or other industry benchmark, first or next patent, first or next copyright, first or next trademark, a functioning manufacturing capability, first or next prototype, first or next supplier relationship, first or next strategic partner, first or next client, first or next $25,000 in revenue, first or next $500,000 in revenue, first or next $1,000,000 in revenue, first or next investment, first or next grant award, first or next employee hire, first or next partner milestone, first or next social medial milestone, first or next thousand followers, first or next 100,000 followers, first or next 1,000,000 followers, financial ratio metric, operating efficiency ratio metric, operating profitability metric, business risk metric, financial risk metric, fraud detection metric, enterprise valuation, and asset valuation (collectively defines: milestone). In a further embodiment of the methods of the instant invention, different segments of an issuer's business may be selected from the list comprising the details of said issuer's securities offering, historical financials, projected financials, social interactions, community-based interactions, industry, broad market, target market, business model, issuer's history as an SME, sales history, sales projections, product, economic climate, valuation, market capitalization, book value of equity, market value of invested capital, number of employees (collectively defines: segments of an issuer's business). In still a further embodiment of the methods of the instant invention said answers of Step 2 above are tagged with external events in the life of said issuer of Step 1 above, said events selected from the group comprising having success at entry into an accelerator, having success at raising money through offering securities to retail investors via alternative investing, and having success at raising money through offering securities to accredited investors or institutional investors (collectively defines: crowd event tag). In a further embodiment of the methods of the instant invention, said questions of Step 1 above must contain attributes from more than one of the listed segments, or between 20% and 80% of the listed segments or preferably more than 50% of the listed segments or more than 80% of the listed segments or all of the listed segments. In a further embodiment of the methods of the instant invention, the number of said questions of Step 1 used to create data range from 1-250, or from 5-100, or from 10-60, or are more than 15, or preferably more than 20, or more preferably more than 30.

### Data

Data of the instant invention is created by industry participants, wherein industry participants take the following steps: (i) defining attributes about one or more alternative investing issuers where the attributes exposed by questions that are selected from different segments of said issuer's business, (ii) further defining the attributes about one or more alternative investing issuers where the attributes are recorded by answers to said questions in Step 1, and (iii) determining said attributes of said one or more alternative investing issuers using techniques selected from the group comprising investment research by one or more industry participants face to face interviews where answers are recorded on paper later transcribed into a digital medium and stored in one or more databases accessible by one or more computing devices, face to face interviews where answers are recorded in a digital medium and stored in or more databases accessible by one or more computing devices, remote interviews where answers are recorded on paper later transcribed into a digital medium and stored in one or more databases accessible by one or more computing devices, remote interviews where answers are recorded in a digital medium and stored in or more databases accessible by one or more computing devices, paper surveys where answers are recorded on paper later transcribed into a digital medium and stored in one or more databases accessible by one or more computing devices, and online surveys where answers are recorded in a digital medium and stored in or more databases accessible by one or more computing devices. In a further embodiment of the data of the instant invention said answers of Step 2 above are in a format selected from the group comprising unstructured, structured, open-ended, semi-structured, and closed. In yet a further embodiment of the data of the instant invention said answers of Step 2 above are comparable from one alternative investing issuer's answers to another. In yet a further embodiment of the data of the instant invention said answers of Step 2 above are converted to a numerical format. In a preferred embodiment of the methods of the instant invention said answers of Step 2 above are tagged with one or more milestones. In still a further embodiment of the data of the instant invention said answers of Step 2 above are tagged with one or more issuer event tags of said issuer of Step 1 above. In still a further embodiment of the data of the instant invention said answers of Step 2 above are tagged with crowd event tags of said issuer of Step 1 above. In a still further embodiment of the data of the instant invention, comprises different segments of an issuer's business. In a further embodiment of the data of the instant invention, said questions of Step 1 above must contain attributes from more than one of the listed segments, or between 20% and 80% of the listed segments or preferably more than 50% of the listed segments or more than 80% of the listed segments or all of the listed segments. In a further embodiment of the data of the instant invention, the number of said questions of Step 1 used to create data range from 1-250, or from 5-100, or from 10-60, or are more than 15, or preferably more than 20, or more preferably more than 30. In a further embodiment of the data of the instant invention, SME Valuators assemble the data created in Steps 1-3 above in a searchable database. In a further embodiment of the data of the instant invention, SME Valuators provide access to said searchable database to industry participants. In a further embodiment of the data of the instant invention, industry participants are stakeholders in the valuation of a business or asset controlled by a business. In a further embodiment of the data of the instant invention, said searchable database includes data useful in evidentiary support selected from the list comprising cost of capital, cost of equity, cost of debt, beta, equity risk premium, industry risk premium, small company risk premium, specific company risk premium, market multiples, price to milestone ratio, price to earnings ratio, price to revenue, price to book, earnings per share, discounts, premiums, control discount, control premium, marketability discount, illiquidity discounts, key-person discounts, size discounts, and lack of voting. In a further embodiment of the data of the instant invention, said searchable database includes industry-specific data not limited to SIC codes and NAICS codes of one or more alternative investing issuers (collectively defines: data useful in evidentiary support).

### Use of Instant Invention by SME Valuators

With the development of retail, non-accredited, private company investing via a change in regulation driven by the JOBSAct, there is a need for this new class of industry participant, retail, non-accredited investor, to gain access to information about investing, and/or the evaluation of private companies. This new class of participant is not able to obtain this information due to the combination of incumbent dis-incentive and regulation. This is detrimental to the industry and to the retail investor.

In an embodiment of the instant invention, a new class of industry participant uses digital's capabilities to transform private company information seen in an alternative investing context into data and make said data publicly available in a manner consistent with regulatory guidelines such that the users of said data create crowd-as-participant data which is assembled and then stored in a database, the used to populate certain database fields which are subsequently made accessible to business valuation professionals for use in enterprise valuation and asset appraisal in the context of transactions, litigation, regulation, and tax (collectively defines: SME Valuators).

In a further embodiment of the instant invention, SME Valuators provide an opportunity for industry participants to access SME data created by SME Valuators in a manner consistent with regulatory guidelines. In a preferred embodiment of the instant invention, SME Valuators use digital's capabilities to provide an opportunity for industry participants to access SME data where said SME data is generated by SME Valuators in a standardized format.

In a still further embodiment of the instant invention SME Valuators provide an opportunity for industry participants to interact with SME data, wherein said interaction is useful in creating evidentiary data purposed for enterprise valuation and appraisal of assets controlled by a business by taking the following steps: (i) retail investors invest in a private SME seeking investment through exemptions Titles I-IV of the JOBSAct (issuer) by purchasing a security, (ii) SME data is made available by SME Valuators in a standardized format, (iii) SME Valuators benchmark the investment decisions made by retail investors in Step 1 against the SME data in Step 2, thus creating crowd-as-participant data and (iv) SME Valuators provide the crowd-as-participant data in Step 3 to retail investors in a compliant fashion. In a further embodiment of the instant invention SME Valuators use digital's capabilities to provide an opportunity for retail investors to interact with SME data by taking the following steps: (i) retail investors invest in a private SME seeking investment through exemptions Titles I-IV of the JOBSAct (issuer) by purchasing a security, (ii) SME data is made available by SME Valuators in a standardized format, (iii) SME Valuators benchmark the investment decisions made by retail investors in Step 1 against the SME data in Step 2 thus creating crowd-as-participant data, (iv) using crowd-as-participant data in Step 3 SME Valuators classify the potential of issuers in Step 1 to be successful at reaching their next milestone (collectively defines: crowd-as-participant-score), (v) SME Valuators provide the score in Step 4 to retail investors in a compliant fashion, (vi) SME Valuators assemble the data created in Steps 1-5 above in a searchable database, and (vii) SME Valuators provide access to said searchable database to industry participants. In a preferred embodiment of the instant invention, industry participants are stakeholders in the valuation of a business or asset controlled by a business. In a further preferred embodiment of the instant invention, said searchable database includes data useful in evidentiary support. In a still further preferred embodiment of the instant invention, said data is used by business valuation professionals to support business valuation and asset appraisal in the context of transactions, litigation, regulation and tax.

In a further embodiment of the instant invention SME Valuators provide an opportunity for industry participants to access SME data where said SME data is generated by SME Valuators in a standardized format by taking the following steps: (i) SME Valuators create SME data in a standardized format, (ii) retail investors decide which issuer to invest in by purchasing a security, (iii) SME Valuators benchmark the investment decisions made by retail investors in Step 2 against the SME data in Step 1, (iv) using SME data in Step 3 SME Valuators classify and score the potential of issuers in Step 1 to be successful at reaching their next milestone, and (v) provide the score in Step 4 to retail investors in a compliant fashion.

In a further embodiment of the instant invention SME Valuators provide an opportunity for industry participants to access multiple types of data and scores useful in the creation of evidentiary data purposed for enterprise valuation and appraisal of assets controlled by a business by taking the following steps: (i) SME Valuators create SME data in a standardized format, (ii) retail investors decide which issuer to invest in by purchasing a security, (iii) SME Valuators benchmark the investment decisions made by retail investors in Step 2 against the SME data in Step 1, (iv) using SME data in Step 3 SME Valuators classify and score the potential of issuers in Step 1 to be successful at reaching their next milestone, (v) SME Valuators benchmark the investment decisions made by retail investors in Step 2 against the SME data in Step 1, (vi) using said data in Step 5, SME Valuators classify and score the potential of issuers in Step 2 to be successful at reaching their next milestone, (vii) SME Valuators compare the expert score in Step 4 with the crowd-as-participant score in Step 6 to create a control-score, (viii) SME Valuators provide control score in step 7 to industry participants in a compliant fashion, (ix) SME Valuators assemble the data created in Steps 1-8 above in a searchable database, and (x) SME Valuators provide access to said searchable database, or reports derived from said searchable database, to industry participants. In a preferred embodiment of the instant invention, industry participants are stakeholders in the valuation of a business or asset controlled by a business. In a preferred embodiment of the instant invention, said searchable database includes data useful in evidentiary support. In a still further preferred embodiment of the instant invention, said data is used by business valuation professionals to support business valuation and asset appraisal in the context of transactions, litigation, regulation and tax.

In a further embodiment of the instant invention SME Valuators provide an opportunity for industry participants to access multiple types of data and scores useful in the creation of evidentiary data purposed for enterprise valuation and appraisal of assets controlled by a business by taking the following steps: (i) SME Valuators create SME data in a standardized format, (ii) retail investors decide which issuer to invest in by purchasing a security, (iii) SME Valuators benchmark the investment decisions made by retail investors in Step 2 against the SME data in Step 1, (iv) using SME data in Step 3 SME Valuators classify and score the potential of issuers in Step 1 to be successful at reaching their next milestone, (v) SME Valuators benchmark the investment decisions made by retail investors in Step 2 against the SME data in Step 1, (vi) using said data in Step 5 SME Valuators classify and score the potential of issuers in Step 2 to be successful at reaching their next milestone, (vii) SME Valuators compare the expert-score in Step 4 with crowd-as-participant-score in Step 6 to create a control-score, (viii) Industry participants use the information created in Step 7 to make decisions, (ix) SME Valuators assemble the data created in Steps 1-8 above in a searchable database, and (x) SME Valuators provide access to said searchable database, or reports derived from said searchable database, to industry participants. In a preferred embodiment of the instant invention, industry participants are stakeholders in the valuation of a business or asset controlled by a business. In a further preferred embodiment of the instant invention, said searchable database includes data useful in evidentiary support. In a still further preferred embodiment of the instant invention, said data is used by business valuation professionals to support business valuation and asset appraisal in the context of transactions, litigation, regulation and tax.

In a further embodiment of the instant invention SME Valuators provide an opportunity for industry participants to access multiple types of data and scores useful in the creation of evidentiary data purposed for enterprise valuation and appraisal of assets controlled by a business by taking the following steps: (i) SME Valuators create SME data in a standardized format, (ii) retail investors decide which issuer to invest in by purchasing a security, (iii) SME Valuators benchmark the investment decisions made by retail investors in Step 2 against the SME data in Step 1, (iv) using SME data in Step 3 SME Valuators classify the potential of issuers in Step 1 to be successful at reaching their next milestone, (v) SME Valuators benchmark the investment decisions made by retail investors in Step 2 against the SME data in Step 1, (vi) using said data in Step 5 SME Valuators classify and score the potential of issuers in Step 2 to be successful at reaching their next milestone, (vii) SME Valuators compare the score in Step 4 with the score in Step 6 to create a control-score, (viii) SME Valuators repeat Steps 1-7 over a period of time ranging from 1 day to 10 years, (ix) Industry participants use the information created in Step 8 to make decisions, (ix) SME Valuators assemble the data created in Steps 1-9 above in a searchable database, and (x) SME Valuators provide access to said searchable database, or reports derived from said searchable database to industry participants. In a further embodiment of the instant invention, the period of time in Step 7 ranges from 1 year, or from 1 day to 1 year, or from 1 year to 3 years, for from 1 day to 3 years, or from 1 day to 5 years, or for more than 5 years, or more than 7 years, or more than 10 years. In a preferred embodiment of the instant invention, said period of time ranges from 1 day to 5 years. In a further embodiment of the instant invention, industry participants are stakeholders in the valuation of a business or asset controlled by a business. In a further embodiment of the instant invention, said searchable database includes data useful in evidentiary support. In a still further preferred embodiment of the instant invention, said data is used by business valuation professionals to support business valuation and asset appraisal in the context of transactions, litigation, regulation and tax.

In a further embodiment of the instant invention SME Valuators provide an opportunity for industry participants to access multiple types of data and scores useful in the creation of evidentiary data purposed for enterprise valuation and appraisal of assets controlled by a business by taking the following steps: (i) SME Valuators create SME data in a standardized format, (ii) retail investors decide which issuer to invest in by purchasing a security, (iii) SME Valuators benchmark the investment decisions made by retail investors in Step 2 against the SME data in Step 1, (iv) using SME data in Step 3 SME Valuators classify and score the potential of issuers in Step 1 to be successful at reaching their next milestone, (v) SME Valuators benchmark the investment decisions made by retail investors in Step 2 against the SME data in Step 1, (vi) using said data in Step 5 SME Valuators classify and score the potential of issuers in Step 2 to be successful at reaching their next milestone, (vii) SME Valuators compare the score in Step 4 with the score in Step 6 to create a control-score, (viii) Industry participants use the information created in Step 7 to educate industry participants, (ix) SME Valuators assemble the data created in Steps 1-8 above in a searchable database, and (x) SME Valuators provide access to said searchable database, or reports derived from said searchable database to industry participants. In a preferred embodiment of the instant invention, industry participants are stakeholders in the valuation of a business or asset controlled by a business. In a further preferred embodiment of the instant invention, said searchable database includes data useful in evidentiary support. In a still further preferred embodiment of the instant invention, said data is used by business valuation professionals to support business valuation and asset appraisal in the context of transactions, litigation, regulation and tax.

In a further embodiment of the instant invention SME Valuators provide an opportunity for industry participants to access multiple types of data and scores useful in the creation of evidentiary data purposed for enterprise valuation and appraisal of assets controlled by a business by taking the following steps: (i) SME Valuators create SME data in a standardized format, (ii) retail investors decide which issuer to invest in by purchasing a security, (iii) SME Valuators benchmark the investment decisions made by retail investors in Step 2 against the SME data in Step 1, (iv) using SME data in Step 3 SME Valuators classify and score the potential of issuers in Step 1 to be successful at reaching their next milestone, (v) SME Valuators benchmark the investment decisions made by retail investors in Step 2 against the SME data in Step 1, (vi) using said data in Step 5 SME Valuators classify and score the potential of issuers in Step 2 to be successful at reaching their next milestone, (vii) SME Valuators compare the score in Step 4 with the score in Step 6 to create a control-score, (viii) SME Valuators repeat Steps 1-7 over a period of time ranging from 1 day to 1 year, or from 1 year to 5 years, or from 5 years to 10 years of preferably every six months for the lifetime of said issuers, (ix) Industry participants use the information created in Step 8 to make decisions, (x) SME Valuator assembles the data created in Steps 1-9 above in a searchable database, and (xi) SME Valuators provide access to said searchable database, or reports derived from said searchable database to industry participants. In a preferred embodiment of the instant invention, industry participants are stakeholders in the valuation of a business or asset controlled by a business. In a further embodiment of the instant invention, said searchable database includes data useful in evidentiary support. In a still further preferred embodiment of the instant invention, said data is used by business valuation professionals to support business valuation and asset appraisal in the context of transactions, litigation, regulation and tax.

In a further embodiment of the instant invention SME Valuators provide evidentiary data useful in enterprise valuation and appraisal of assets controlled by a business by taking the following steps: (i) SME Valuators create SME data in a standardized format, (ii) retail investors decide which issuer to invest in by purchasing a security, (iii) SME Valuators benchmark the investment decisions made by retail investors in Step 2 against the SME data in Step 1, (iv) using SME data in Step 3 SME Valuators classify and score the potential of issuers in Step 1 to be successful at reaching their next milestone, (v) SME Valuators benchmark the investment decisions made by retail investors in Step 2 against the SME data in Step 1, (vi) using the data in Step 5 SME Valuators classify the potential of issuers in Step 2 to be successful at reaching their next milestone, (vii) SME Valuators compare the score in Step 4 with the score in Step 6 to create a control-score, (viii) SME Valuators repeat Steps 1-7 over a period of time ranging from 1 day to 1 year, or from 1 year to 5 years, or from 5 years to 10 years of preferably every six months for the lifetime of said issuers, (ix) SME Valuators assemble the data created in Steps 1-9 above in a searchable database, and (x) SME Valuators provide access to said searchable database, or reports derived from said searchable database to industry participants. In a preferred embodiment of the instant invention, industry participants are stakeholders in the valuation of a business or asset controlled by a business. In a further preferred embodiment of the instant invention, said searchable database includes data useful in evidentiary support. In a still further preferred embodiment of the instant invention, said data is used by business valuation professionals to support business valuation and asset appraisal in the context of transactions, litigation, regulation and tax.

In an embodiment of the methods of the instant invention SME Valuators evaluate one or more alternative investing issuers by taking the following steps: (i) performing a primary screening evaluation of one or more alternative investing issuers using a subset of data selected from the group consisting of SME data, expert-data, crowd-as-expert data and control-data statistically shown to track the success or failure of an issuer to reach their next milestone (collectively defines: stoplight screen), (ii) reading the stoplight screen's three score readout to make an initial assessment as to the fitness of said one or more issuers in Step 1 to successfully reach their next milestone where the three score readout comprises above average (green), average (amber), and below average (red) (stoplight-score), (iii) obtaining a score selected from the group consisting of expert-score, crowd-as-participant-score, and control-score for said one or more issuers in Step 2 having a stoplight-score selected from the group consisting of red, amber and green, and (iv) providing said score from Step 3 to industry participants. In a further embodiment of the instant invention, SME Valuators make use of more than 1 milestone in the creation of data, or between 1 and 3 milestones, or between 3 and 10 milestones, or between 10 and 20 milestones, or more than 15 milestones, or more than 25 milestones. In a preferred embodiment of the instant invention, SME Valuators make use of between 10 and 20 milestones.

### Expert Score

Methods of the instant invention comprise the creation of expert scores by industry participants. In an embodiment of the methods of the instant invention an expert score is created by industry participants taking the following steps: (i) defining attributes about one or more alternative investing issuers where the attributes exposed by questions that are selected from different segments of said issuer's business, (ii) further defining the attributes about one or more alternative investing issuers where the attributes are recorded by answers to said questions in Step 1, (iii) determining said attributes of said one or more alternative investing issuers using techniques selected from the group comprising investment research by one or more industry participants, face to face interviews where answers are recorded on paper later transcribed into a digital medium and stored in one or more databases accessible by one or more computing devices, face to face interviews where answers are recorded in a digital medium and stored in or more databases accessible by one or more computing devices, remote interviews where answers are recorded on paper later transcribed into a digital medium and stored in one or more databases accessible by one or more computing devices, remote interviews where answers are recorded in a digital medium and stored in or more databases accessible by one or more computing devices, paper surveys where answers are recorded on paper later transcribed into a digital medium and stored in one or more databases accessible by one or more computing devices, and online surveys where answers are recorded in a digital medium and stored in or more databases accessible by one or more computing devices, (iv) weighting said questions of Step 1 according to the implications of said questions on the real-life of said issuer in Step 1, where said rankings are determined by industry experts, (v) ranking said answers in Step 2 as having a range of negative, neutral or positive impacts on the real-life of said issuer of Step 1, where said rankings are determined by industry experts, (vi) querying the database in Step 3 for said issuer answers of Step 2, (vii) manipulating the ranked score of said answers in Step 6 with said question weights of Step 4 to obtain a numerical value for each answer, (viii) summing said numerical values of Step 7 to obtain a score, (ix) using said score in Step 8 to create a letter grade A for the highest range of said scores in Step 8, letter grade B for the next highest range of said scores in Step 8, letter grade C for the next highest range of said scores in Step 8 and letter grade D for the next highest range of said scores in Step 8, (x) performing Steps 1-9 for additional one or more alternative investing issuers, (xi) determining the success or failure of said issuers from Steps 1-10 to reach one or more internal event tags, (xii) adjusting said weights in Step 4 such that 100% of said letter grade A from Step 9 achieved said success in Step 11, from 60-70% of said letter grade B from Step 9 achieved said success in Step 11, from 30-40% of said letter grade C from Step 9 achieved said success in Step 11, and from 10-20% of said letter grade D from Step 9 achieved said success in Step 11, (xiii) locking the numerical values of said weights in Step 12 for a period of time to be determined by industry participants ranging from one day to 5 years, or more preferably from 1 month to one year, and (xiv) manipulating said scores in Step 6 and weights of Step 12 to determine a final score and letter grade. In a further embodiment of the methods of the instant invention said answers of Step 2 above are in a format selected from the group comprising unstructured, structured, open-ended, semi-structured, and closed. In yet a further embodiment of the methods of the instant invention said answers of Step 2 above are comparable from one alternative investing issuer's answers to another. In yet a further embodiment of the methods of the instant invention said answers of Step 2 above are converted to a numerical format. In still a further embodiment of the methods of the instant invention said answers of Step 2 above are tagged with one or more issuer event tags in the life of said issuer of Step 1 above. In still a further embodiment of the methods of the instant invention the weights of said questions in Step 4 above range from 1,000 to −1,000, or preferably from 500 to −500, or more preferably from 100 to −100. In still a further embodiment of the methods of the instant invention the rankings of said answers in Step 5 above are given alphabetical rankings. In still a further embodiment of the methods of the instant invention the rankings of answers in Step 5 above are given numerical rankings, where said ranking's number can be in the range of 1,000 to −1,000 or preferably 500 to −500, or more preferably from 100 to −100. In a further embodiment of the instant invention, SME Valuators assemble the data created in Steps 1-12 above in a searchable database. In a further embodiment of the instant invention, SME Valuators provide access to said searchable database to industry participants. In a further embodiment of the instant invention, industry participants are stakeholders in the valuation of a business or asset controlled by a business. In a further embodiment of the instant invention, said searchable database includes data useful in evidentiary support. In a still further embodiment of the methods of the instant invention, comprises different segments of an issuer's business. In a further embodiment of the data of the instant invention, said questions of Step 1 above must contain attributes from more than one of the listed segments, or between 20% and 80% of the listed segments or more than 50% of the listed segments or more than 80% of the listed segments or all of the listed segments.

### Crowd-as-Participant Score

Methods of the instant invention comprise the creation of crowd-as-participant scores by industry participants. In an embodiment of the methods of the instant invention a crowd-as-participant score is created by industry participants taking the following steps: (i) defining attributes about one or more alternative investing issuers where the attributes exposed by questions that are selected from different segments of said issuer's business, (ii) further defining the attributes about one or more alternative investing issuers where the attributes are recorded by answers to said questions in Step 1, (iii) determining said attributes of said one or more alternative investing issuers using techniques selected from the group comprising investment research by one or more industry participants, face to face interviews where answers are recorded on paper later transcribed into a digital medium and stored in one or more databases accessible by one or more computing devices, face to face interviews where answers are recorded in a digital medium and stored in or more databases accessible by one or more computing devices, remote interviews where answers are recorded on paper later transcribed into a digital medium and stored in one or more databases accessible by one or more computing devices, remote interviews where answers are recorded in a digital medium and stored in or more databases accessible by one or more computing devices, paper surveys where answers are recorded on paper later transcribed into a digital medium and stored in one or more databases accessible by one or more computing devices, and online surveys where answers are recorded in a digital medium and stored in or more databases accessible by one or more computing devices, (iv) querying said database of Step 3 for crowd event tagged issuers, (v) comparing individual answers of said issuers of Step 4, (vi) determining a percentage of said answers in Step 5, (vii) finding the numerical difference of the percentages in Step 6, (viii) summing the differences found in Step 7 to obtain the score, (ix) using the score in Step 8 to determine a letter grade, (x) performing Steps 1-9 for additional one or more alternative investing issuers, (xi) determining the success or failure of said issuers from Steps 1-10 to reach one or more crowd event tags, (xii) adjusting said weights in Step 4 such that 100% of said letter grade A from Step 9 achieved said success in Step 11, from 60-70% of said letter grade B from Step 9 achieved said success in Step 11, from 30-40% of said letter grade C from Step 9 achieved said success in Step 11, and from 10-20% of said letter grade D from Step 9 achieved said success in Step 11, (xiii) locking the numerical values of said weights in Step 12 for a period of time to be determined by industry participants ranging from one day to 5 years, or more preferably from 1 month to one year, (xiv) manipulating said scores in Step 6 and weights of Step 12 to determine a final score and letter grade, (xv) providing said score and said letter grade in Step 14 to industry participants. In a further embodiment of the methods of the instant invention said answers of Step 2 above are in a format selected from the group comprising unstructured, structured, open-ended, semi-structured, and closed. In yet a further embodiment of the methods of the instant invention said answers of Step 2 above are comparable from one alternative investing issuer's answers to another. In yet a further embodiment of the methods of the instant invention said answers of Step 2 above are converted to a numerical format. In still a further embodiment of the methods of the instant invention said answers of Step 2 above are tagged with one or more issuer event tags in the life of said issuer of Step 1 above. In still a further embodiment of the methods of the instant invention said answers of Step 2 above are tagged with one or more crowd event tags in the life of said issuer of Step 1 above. In a further embodiment of the instant invention, SME Valuators assemble the data created in Steps 1-13 above in a searchable database. In a further embodiment of the instant invention, SME Valuators provide access to said searchable database to industry participants. In a further embodiment of the instant invention, industry participants are stakeholders in the valuation of a business or asset controlled by a business. In a further embodiment of the instant invention, said searchable database includes data useful in evidentiary support. In a still further embodiment of the methods of the instant invention, comprises different segments of an issuer's business. In a further embodiment of the data of the instant invention, said questions of Step 1 above must contain attributes from more than one of the listed segments, or between 20% and 80% of the listed segments or more than 50% of the listed segments or more than 80% of the listed segments or all of the listed segments.

### Control Score

Methods of the instant invention comprise the creation of control scores by industry participants. In an embodiment of the instant invention an industry participant creates a control score by taking the following steps: (i) obtaining one or more expert scores for one or more issuers, (ii) obtaining one or more crowd-as-participants scores for one or more issuers, (iii) comparing the scores of Step 1 and Step 2, (iv) manipulating any difference between the comparison of Step 3 to create a control score, (v) repeat Steps 1-4 for one or more alternative investing issuers, and (vi) providing said score in Step 4 to industry participants. In an embodiment of the methods of the instant invention, said issuers of Step 1 and Step 2 are selected from the group comprising one issuer, more than one issuer, a group of different issuers, a group of the same issuers, a group of a mix of different and same issuers, issuers having one or more specific attributes, issuers having one or more internal event tags, and issuers having one or more crowd based tags. In an embodiment of the methods of the instant invention, one or more types of said manipulation of Step 4 are selected from the group comprising combining the scores of Step 3, maintaining the scores of Step 3 separately, averaging the scores of Step 3, using the difference between the score in Step 1 and the score in Step 2 as a means of creating a standard deviation for the score in Step 1, and using the difference between the score in Step 1 and the score in Step 2 as a means of creating a standard deviation for the score in Step 2. In a yet further embodiment of the methods of the instant invention, Steps 1-4 are repeated the number of times selected from the group comprising more than once, twice, more than three times, between 6 and 12 times, more than 24 times, and more than 100 times over the course of time selected from the duration comprising one day, more than one day, one week, more than one week, one month, more than one month, one quarter, more than one quarter, 6 months, 9 months, one year, more than one year, three years, five years, and more than five years and the scores manipulated in a manner selected from the group comprising chronological comparison of individual scores, averaged scores, a comparison of individual scores with averaged scores, presentation of one score in light of the other, and presentation of crowd-as-participant score. In a further embodiment of the instant invention, SME Valuators assemble the data created in Steps 1-13 above in a searchable database. In a further embodiment of the instant invention, SME Valuators provide access to said searchable database to industry participants. In a further embodiment of the instant invention, industry participants are stakeholders in the valuation of a business or asset controlled by a business. In a further embodiment of the instant invention, said searchable database includes data useful in evidentiary support.

### Use of Instant Invention by Industry Participants

In an embodiment of the methods of the instant invention an industry participant is educated about different issuer investments by taking the following steps: (i) identifying one or more alternative investing issuers, (ii) identifying the expert-score of one or more alternative investing issuers, (iii) comparing expert-scores in Step 2, and (iv) optionally investing in a security offered by one or more alternative investing issuers. In an embodiment of the methods of the instant invention an industry participant is educated about different issuer investments by taking the following steps: (i) identifying one or more alternative investing issuers, (ii) identifying the crowd-as-participant-score of one or more alternative investing issuers, (iii) comparing crowd-as-participant scores in Step 2, and (iv) optionally investing in a security offered by one or more alternative investing issuers. In an embodiment of the methods of the instant invention a industry participant is educated about different issuer investments by taking the following steps: (i) identifying one or more alternative investing issuers, (ii) identifying the control-score of one or more alternative investing issuers, (iii) comparing control scores in Step 2, and (iv) optionally investing in a security offered by one or more alternative investing issuers.

In an embodiment of the methods of the instant invention an industry participant is educated about different issuer investments across the industry by taking the following steps: (i) identifying one or more alternative investing issuers, (ii) identifying the expert-score of one or more alternative investing issuers, (iii) comparing crowd-as-participant scores in Step 2, (iv) analyzing the ability of one more alternative investing issuers to hit one or more milestones, and (v) optionally investing in a security offered by one or more alternative investing issuers. In an embodiment of the methods of the instant invention an industry participant is educated about different issuer investments across the industry by taking the following steps: (i) identifying one or more alternative investing issuers, (ii) identifying the control-score of one or more alternative investing issuers, (iii) comparing crowd-as-expert scores in Step 2, (iv) analyzing the ability of one more alternative investing issuers to hit one or more milestones, and (v) optionally investing in a security offered by one or more alternative investing issuers. In an embodiment of the methods of the instant invention an industry participant is educated about different issuer investments across the industry by taking the following steps: (i) identifying one or more alternative investing issuers, (ii) identifying the crowd-as-participant score of one or more alternative investing issuers, (iii) comparing crowd-as-participant scores in Step 2, (iv) analyzing the ability of one more alternative investing issuers to hit one or more milestones, and (v) optionally investing in a security offered by one or more alternative investing issuers. In an embodiment of the methods of the instant invention an industry participant is educated about different issuer investments across the industry by taking the following steps: (i) identifying one or more alternative investing issuers, (ii) identifying the control-score of one or more alternative investing issuers, (iii) comparing control-scores in Step 2, and (iv) optionally investing in a security offered by one or more alternative investing issuers.

In an embodiment of the methods of the instant invention an industry participant evaluates different issuer investments by taking the following steps: (i) identifying one or more alternative investing issuers, (ii) identifying the expert-score of one or more alternative investing issuers, (iii) comparing expert scores in Step 2, (iv) analyzing the ability of one more alternative investing issuers to hit one or more milestones, and (v) optionally investing in a security offered by one or more alternative investing issuers. In an embodiment of the methods of the instant invention an industry participant evaluates different issuer investments by taking the following steps: (i) identifying one or more alternative investing issuers, (ii) identifying the crowd-as-participant score of one or more alternative investing issuers, (iii) comparing crowd-as-participant scores in Step 2, (iv) analyzing the ability of one more alternative investing issuers to hit one or more milestones, and (v) optionally investing in a security offered by one or more alternative investing issuers. In an embodiment of the methods of the instant invention an industry participant evaluates different issuer investments taking the following steps: (i) identifying one or more alternative investing issuers, (ii) identifying the control-score of one or more alternative investing issuers, (iii) comparing control-scores in Step 2, (iv) analyzing the ability of one more alternative investing issuers to hit one or more milestones, and (v) optionally investing in a security offered by one or more alternative investing issuers.

In an embodiment of the methods of the instant invention a regulator determines the level of fraud or gaming in the different issuer investments across the industry by taking the following steps: (i) identifying one or more alternative investing issuers, (ii) identifying the expert-score of one or more alternative investing issuers, (iii) comparing expert-scores in Step 2, and (iv) analyzing the ability of one more alternative investing issuers to hit one or more milestones. In an embodiment of the methods of the instant invention a regulator determines the level of fraud or gaming in the different issuer investments across the industry by taking the following steps: (i) identifying one or more alternative investing issuers, (ii) identifying the crowd-as-participant score of one or more alternative investing issuers, (iii) comparing crowd-as-participant scores in Step 2, (iv) invest in a security offered by one or more alternative investing issuers. In an embodiment of the methods of the instant invention a regulator determines the level of fraud or gaming in the different issuer investments across the industry by taking the following steps: (i) identifying one or more alternative investing issuers, (ii) identifying the control-score of one or more alternative investing issuers, (iii) comparing control-scores in Step 2, and (iv) analyzing the ability of one more alternative investing issuers to hit one or more milestones.

In an embodiment of the methods of the instant invention an industry participant evaluates one or more alternative investing issuers by taking the following steps: (i) performing a primary screening evaluation of one or more alternative investing issuers using a subset of data selected from the group consisting of expert-data, crowd-as-expert data and control-data statistically shown to track the success or failure of an issuer to raise money through alternative investing (stoplight screen), (ii) reading the stoplight screen's three score readout to make an initial assessment as to the fitness of said one or more issuers in Step 1 to successfully raise money through alternative investing where the three score readout comprises above average (green), average (amber), and below average (red) (stoplight-score), (iii) obtaining a score selected from the group consisting of expert-score, crowd-as-participant-score, and control-score for said one or more issuers in Step 2 having a stoplight-score selected from the group consisting of red, amber and green, and (iv) providing said score from Step 3 to industry participants.

### Database

The methods and uses of the instant invention create digital information in the form of the data of the instant invention that is stored in one or more databases and controlled via one or more computing devices. A database of the instant invention may be a relational, or non-relational database. Means for creating and using databases are well known in the art. Methods for creating and using databases are well known in the art. In an embodiment of the database of the instant invention, certain fields of a database are populated with information generated by creating data. In an embodiment of the database of the instant invention, certain fields of a database are populated with information generated by the creation of crowd-as-participant data. In an embodiment of the instant invention certain fields of a database are populated with SME data. In an embodiment of the database of the instant invention, certain fields of a database are populated with information generated by the creation of control scores. In an embodiment of the database of the instant invention, certain fields of a database are populated with information generated by the creation of one or more expert scores. In an embodiment of the database of the instant invention, certain fields of a database are populated with information generated by the creation of one or more crowd-as-participant scores. In an embodiment of the database of the instant invention certain fields of a database are populated with information generated by one or more expert scores, one or more crowd-as-expert scores, and one or more control scores. In an embodiment of the database of the instant invention, said fields of said database can be populated by a retail investor, a regulator, an SME Valuator, other industry participant, or by an automated computer program. In an embodiment of the database of the instant invention certain fields are populated with data that are used to create evidentiary data. In an embodiment of the database of the instant invention, said certain fields used to create evidentiary data are populated with crowd-as-participant data. In an embodiment of the database of the instant invention said evidentiary data is used by stakeholders in a business valuation for transactional, litigation, regulatory, or tax purposes. In an embodiment of the database of the instant invention, certain fields populated with data or control data that are used to assist in the determination of trends, wherein a trend may be a loosening of investors' investment decisioning standards, wherein said certain fields are optionally populated with control scores. In a further embodiment of the database of the instant invention, SME Valuators assemble evidentiary data, wherein said evidentiary data is accessed by one or more industry participants to perform business valuation or asset appraisal.

### Evidentiary Data

In a preferred embodiment of the uses of the instant invention, evidentiary data is used by industry participants to provide information useful in support of advisory services or in the valuation of a business, wherein said valuation of a business is performed by an industry participant for a purpose selected from the list comprising transactional, litigation, regulatory, and tax, and wherein said evidentiary data is obtained by accessing one or more databases, wherein said one or more databases are comprised of fields populated by one or more selections of compiled information selected from the group comprising data, SME data, crowd-as-participant data, expert score, crowd-as-participant score, and control score, wherein said selections of compiled information contain information selected from the group comprising one or more issuer event tags, one or more segments of an issuer's business, one or more crowd event tags, one or more instances of data useful in evidentiary support, and one or more milestones, and wherein said selections of compiled information derive from industry participants interacting with transactions in alternative investing via the capabilities of digital.

In a preferred embodiment of the data of the instant invention, evidentiary data provides industry participants to information useful in support of providing advisory services, or in the valuation of a business, wherein said valuation of a business is performed by an industry participant for a purpose selected from the list comprising transactional, litigation, regulatory, and tax, and wherein said evidentiary data is obtained by accessing one or more databases, wherein said one or more databases are comprised of fields populated by one or more selections of compiled information selected from the group comprising data, SME data, crowd-as-participant data, expert score, crowd-as-participant score, and control score, wherein said selections of compiled information contain information selected from the group comprising one or more issuer event tags, one or more segments of an issuer's business, one or more crowd event tags, one or more instances of data useful in evidentiary support, and one or more milestones, and wherein said selections of compiled information derive from industry participants interacting with transactions in alternative investing via the capabilities of digital.

In a preferred embodiment of the methods of the instant invention, evidentiary data is created by industry participants to provide information useful in support of advisory services, or in the valuation of a business, wherein said valuation of a business is performed by an industry participant for a purpose selected from the list comprising transactional, litigation, regulatory, and tax, and wherein said evidentiary data is obtained by accessing one or more databases, wherein said one or more databases are comprised of fields populated by one or more selections of compiled information selected from the group comprising data, SME data, crowd-as-participant data, expert score, crowd-as-participant score, and control score, wherein said selections of compiled information contain information selected from the group comprising one or more issuer event tags, one or more segments of an issuer's business, one or more crowd event tags, one or more instances of data useful in evidentiary support, and one or more milestones, and wherein said selections of compiled information derive from industry participants interacting with transactions in alternative investing via the capabilities of digital.

### General

Throughout this specification, unless specifically stated otherwise or the context requires otherwise, reference to a single step, or group of steps shall be selected to encompass one and a plurality (i.e. one or more) of those steps, or groups of steps. Each embodiment described herein is to be applied mutatis mutandis to each and every other embodiment unless specifically stated otherwise. Those skilled in the art will appreciate that the instant invention is susceptible to variations and modifications other than those specifically described. It is to be understood that the disclosure includes all such variations and modifications. The disclosure also includes all of the steps and features referred to or indicated in this specification, individually or collectively, and any and all combinations or any two or more of said steps or features. Functionally equivalent products, compositions and methods are clearly within the scope of the disclosure.

The instant invention can be performed without undue experimentation using, unless otherwise indicated, digitally-enabled conventional techniques of business valuation, credit decisioning, investing strategies, or proforma financial analysis, via one or more computing devices and one or more databases.

### Definitions

For the purposes of the instant invention, “alternative investing” shall have the scope as defined by Titles I-IV of the JOBSAct of 2012, and shall include but not be limited to investing in a security where many investors invest a little money, securities alternative investing, peer-to-peer lending, peer-to-business lending, marketplace lending, and small business lending through credit unions.

For the purposes of the instant invention “industry participants” shall include retail investors, accredited investors, regulated portals, peer-to-business lenders, marketplace lenders, broker dealers, investment advisors, SME Valuators, credit unions, cooperative associations, policy makers, regulators, company, governmental organization, a non-governmental organization, one or more angel investors, community bank, credit union, regulated portal, judge, attorney, certified public accountant, defendant, plaintiff, the Internal Revenue Service, and party to an event selected from the following list comprising business or asset transaction, business litigation, regulation of business finance, business-related tax.

For the purposes of the instant invention “decisions” shall take the meaning to include but not be limited to: (i) industry participants choosing to invest in a security offered by an issuer, or (ii) industry participants determining the relative abilities of expert data and crowd-as-participant data to classify the ability of an issuer to successfully meet their next milestone, or (iii) industry participants determining the relative abilities of expert data, crowd-as-participant data, expert score, crowd-as-participant score, or control score to detect fraud, or gaming the system by issuers, or (iv) the ability of a form of combining expert data and crowd-as-participant data to provide industry participants to classify the ability of an issuer to successfully reach their next milestone, or (v) the ability of an expert score, crowd-as-participant score or control score to provide industry participants with an ability to classify the ability of an issuer to successfully meet their next milestone.

The Patent and Non-Patent Documents listed below are hereby incorporated by reference.

### EXAMPLES

### Example 1

### Background & Objectives

In any community setting, it is a challenge to maintain individual decision-making and avoid the phenomenon known as ‘herding’. The following is a description of Study No. 001 entitled “Validation of Catapult Surveyor for use as Categorization Tool for the Fundability of Companies Seeking Funding Through Securities-based Platforms.” The specific objectives of the Study were: (i) to design a standardized evaluation tool that could be completed in under ninety minutes by one of ordinary skill and have the potential to aggregate the vast majority of an issuer's investor-directed information, and (ii) determine the ability of the tool to reliably classify good and bad investment opportunities.

### Methods

The Study made use of information provided for investment evaluation on crowdfunding portals in the United Kingdom, The Netherlands, and Sweden. In the pre-study stage, a series of questions meant to interrogate the fundamentals of a business were iterated, and resulted in the series of questions and answers referred to as Surveyor Questionnaire v2.1.3, represented below. During the data acquisition stage, for a period of three months all companies asking for more than $35,000 in investment on the selected platforms were selected into the study and evaluated using the v2.1.3 questions and answers below.

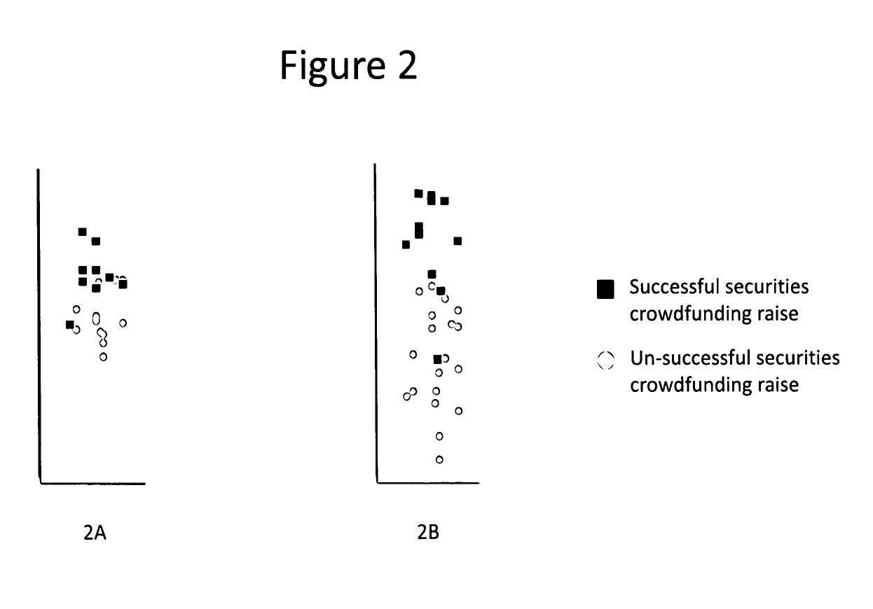

In the evaluation of an alternative investing issuer, dubbed A000001, expert data was created by taking the following steps:
(i) defining attributes of A000001 via the following questions: 1. What was the Company's revenue for the most recent full year? 2. What was the Company's annual sales growth over the previous two years? 3. What are the 1, 3 or 10-year average growth rates for the Company's industry (cite the longest timeframe)? 4. What is the size of the narrowest segment of the Company's market (in sales) using most recently available data for a sales year? 5. What is the estimated time to market for the company's offering? 6. How many other companies are selling similar products/services in the same market? 7. What is the basis of the Company's competitive advantage? Choices: Intellectual property, operational, customer. 8. Does the company have proof of demand for its products? 9. How long until the Company projects to achieve a positive EBIT for two consecutive quarters? 10. How long until the Company projects to achieve a positive, sustainable cash flow for two consecutive quarters? 11. What is the Company's current market share? 12. What is the stage of maturity of the Company's market? 13. How many companies collectively control 65% of the market? 14. What is the 2-year average operating margin for the industry? 15. What was the Company's average operating margin during the previous two years? 16. How long ago was the Company Founded? 17. In what industry is the Company operating? 18. What market does the Company primarily serve? 19. What is the Company's highest Projected Monthly Net Decrease in Cash? 20. What is the Company's competitive strategy? 21. How much of the final retail price is the Company able to capture? 22. How many followers does the Company have on Twitter? 23. How many likes does the Company, or a Company product, have on Facebook? 24. What is the stage of maturation of the Company's Social Community? 25. What type of brand recognition does the Company, a Founder, or one of its products, enjoy? 26. How much money is the Company looking to raise in the next 2 years? 27. What is the Company giving in return for the raise? 28. What percentage of the Company are the Founders offering in return for the raise? 29. What interest rate is the Company paying to its debt investors in return for the raise? 30. How many units of product is the Company giving away in return for the raise? 31. What is the reason for the company's raison d'etra? Choices: Regulatory change, a ten-fold change in ten years or less, reconstruction of value chain and channels of distribution, proprietary or contractual advantage, existing management and/or investors either burned out or under managed, new entrepreneurial leadership, existing market leaders are either customer obsessed or customer blind, imperfect information and markets, or disruptive technology and exogenous events. 32. Describe the stage of the Company's main product. 33. What is the status of the Company's relationship with Presumers of its product? 34. What is the fold difference between the Company's operating margin and the industry average? 35. How many previous companies in the same industry & similar market have attempted to raise money via a alternative investing platform in the past 18 months? 36. Does the Company's business model necessarily place it into the position of having to discuss the following: Choices: sex, religion, morality, politics, money, toilet habits,
(ii) accessing the specific attributes defined said questions of Step 1 by obtaining answers defined as: 1. >1,000,000, >100,000<1,000,000, >25,000<100,00, <25,000, 2. >30%, >5%<30%, <5%, Negative, NA, 3. >30%, >5%<30%, <5%, Negative, 4. >200,000,000, >20,000,00<200,000,000, <20,000,000, 5. <6 months, >6 months<2 years, >2 years, 5. >, 6, >1<5, 0, 7. Two or more of the above, One of the above, None of the above, 8. Pre-sales, Demonstrable Customer Interest, Contracts, Letters of Intent, Nothing, 9. <6 months, >6 months<2 years, >2 years, 10. <6 months, >6 months<2 years, >2 years, 11. >10%, >3%<10%, <3%, NA, 12. Company is helping to create the market, Emerging, Mature, Declining, 13. >200, >10<200, <10, NA, 14. Answer: ______, 15. Answer: ______, 16. Answer: ______, 16. Answer: ______, 17. Answer ______, 18. Answer: ______, 19. ______, 20. Low Cost Leadership, Differentiated Product at Lower Cost, Differentiated Product at Higher Cost, Differentiated Product in a Niche, 21. <5%, >5%<10%, >10%<20%, >20%<30%, >30%<50%, >50%, Unable to determine, 22. Answer: ______, 23. Answer: ______, 24. Company strategy driven by community perspective, Identifiable community initiatives with measurable business outcomes, Identifiable community initiatives, Experimental, or ad hoc use of social technology, 25. Two or more of the above, One of the above, None of the above, 26. <25,000, >25,000<99,000, >99,000<250,000, >251,000<500,000, >500,000<749,000, >749,000<1,000,000, >1,000,000, 27. Product only, Debt Security, Equity, 28. <5%, >5%<11%, >11%<16%, >16%<21%, >21%<26%, >26%<31%, >31%, NA, 29. <2.5%, >2.5%<5%, >5%<8%, >8%<11%, >11%<14%, >14%, NA, 30. <100 units, >100<250 units, >250<500 units, >500<1,000 units, >1,000<2,500 units, >2,500 units, NA, 31. Three or more of the above, Two of the above, One of the above, None of the above, 32. On market with sales history of >6 months, Prototype with demonstrable customer interactions, Working concept, Idea, 33. Defined strategy to build community-based interactions with a measurable two-way interaction, Defined strategy to build community-based interactions, Ad-hoc interactions, I do not know what is a Presumer. 34. >1.0x<1.5x, >1.5x<2.5x, >2.5x<5x, >5x 35. Three or Four successfully, One or Two successfully, Five or more successfully, None, One or more unsuccessfully. 36. None of the above, One of the above, Two of the above, Three or more of the above,
(iii) attributes of A000001 were determined by investment research by one or more industry participants by selecting one answer from Step 2 above to the corresponding question of Step 1 above to obtain the following ranking in alphabetical format and place into certain fields in a database of the instant invention: 1D, 2E, 3A, 4C, 5A, 6C, 7A, 8D, 9B, 10B, 11D, 12A, 13D, 15%, 9%, 0.60, 1, Securities-based Alternative investing, Funding Facilitators, Funding Seekers, Investors, Industry Stakeholders, >50,000<200,000, 20D, 21F, 150, 0, 24C, 25C, 26D, 27C, 28D, 29G, 30G, 31B, 32D, 35D, and 36A,
(iv) said questions of Step 1 were weighted according to one or more industry participants' belief as to the relative impact of a question the real-life of A000001. Unless otherwise stated, said question has an industry expert weight of 1. Question 4=3, Question 9=5, Question 17=3, Question 25=3, Question 31=3, Question 32=5, and Question 14/15 relationship=3,
(v) said answers of Step 2 were given ranked scores of −3, 0, 1, 3, or 9 where the higher the number the better. Rankings were dependent on said industry experts' determination as to their impact on the real-life of A000001, such ranked scores readily understood by one familiar with the art of business valuation. For example, an issuer having a product that has been on the market for more than six months is in a better position to obtain resources than does a company whose product is at the prototype stage,
(vi) manipulation of the weights of Step 3 and the rankings of Step 4 yielded A000001 an expert score of 103 that was entered into a database of the instant invention using a computing device,
(vii) Steps 1-5 were repeated for 31 other alternative investing issuers, whose scores were placed into a database of the instant invention, and analyzed (results seen in FIG. 2A). Retrieving and analyzing said scores from said database using a computing device placed A000001 in the expert-derived range of 34% of the top score of the other alternative investing issuers,
(viii) a crowd-as-participant score was obtained by reviewing the crowd base tag of success or failure at raising money through alternative investing which added the following weights to adjust to the crowd's view on in what companies are worth investing. These additional weights should be considered equal to 1 unless stated otherwise. Question 17=3, Question 25=3, and Question 35=3,
(ix) Manipulation of the adjusted weights and score yielded A000001 a crowd-as-participant score of 1545, with the other 31 issuer's scores were obtained by the same methodology (results seen in FIG. 2B). Retrieving and analyzing said score from said database using a computing device placed A000001 in the crowd-derived range of 38% of the top score of the other alternative investing issuers.
(x) Accessing the database of the instant invention by the use of a computing device, different types of control scores were obtained by manipulating A000001's said expert score in Step 4, said expert score percentile in Step 5, said crowd-expert score in Step 6 and said crowd-as-expert percentile in Step 6. A first control score was obtained by taking the average of 103 and 1545 to yield 824. A second control score was obtained by describing 1545 as having a ‘deviation’ of 103, so as to say 1545+/−103. A third control score was obtained by taking the divisor of the two scores and describing the score as 15×103. A fourth control score was derived by subtracting 103 from 1545 to obtain 1442. A fifth control score was derived by adding 103 to 1545 to obtain 1648. A sixth control score was obtained by averaging 34 and 38% to yield 36%. A seventh control score was obtained by taking the average percentile, 36%, and using ½ the difference of 34% and 38% as the ‘deviation’, so as to say 36%+/−2%. An eighth control score was obtained by using the crowd-as-expert score. It should be appreciated that each issuer in the database of the instant invention was treated using the same manipulations so as to maintain comparability between issuers. The control scores were used by industry participants to discuss not only the appropriateness or utility or predictability or abilities of either or both scores to educate, and inform industry participants, but also the ability of the scores of the instant invention to track fraud, or gaming of the system by issuers.

### Conclusion

The Results of Study 001 included the demonstration of an ability to classify an issuer's potential for success and failure in a fundraising effort (Student's T Test—unequal variance, heteroscedastic) with a p value of 0.001.

### REFERENCES

### Us Patent Documents

| | | |
|---|---|---|
| 5,235,701 | 574,587 | Ohler et al |
| 4,779,187 | 722,052 | Letwin, James |
| 4,084,233 | 689,822 | Handly et al |
| 2002/0174049 | 10/143,950 | Kitahara, Yasutomi |
| 2009/0030849 | 11/827,511 | Hahn, Brian |

### Non-Patent Documents

| | |
|---|---|
| Ahlers 2012 | Ahlers, G, Cumming D, Guenther C, Schweizer, D. |
| | Signaling in Equity Crowdfunding. Social Science |
| | Research Network. 2012. |
| Aitamurto 2011 | Aitamutro, Tanja et al. The Promise of Idea |
| | Crowdsourcing - Benefits, Contexts, Limitations. |
| | Nokia White Paper, June 2011. |
| Deloitte 2014 | Digital disruption. Threats and opportunities for |
| | retail financial services. Deloitte Touche |
| | Tohmatsu, United Kingdom. 2014. |
| Doan 2011 | Doan, A. et al. Crowdsourcing Systems on the |
| | World-Wide Web. Communications of the ACM |
| | Vol 54, No. 4. 2011. |
| Duff & Phelps 2016 | Duff & Phelps. 2016 Valuation Handbook, Guide to |
| | Cost of Capital. Wiley & Sons. 2016. Book. 2016. |
| McKinsey 2015 | Karel Doerner, David Edelman. What ‘digital’ |
| | really means. McKinsey & Company Insights. July |
| | 2015. |
| Pratt 2008 | Shannon Pratt, Alina Niculita. Valuing a Business, |
| | the analysis and appraisal of closely held |
| | companies. McGraw Hill. 2008. Book. |
| Pratt 2014. | Shannon Pratt, Roger Grabowski. Cost of Capital, |
| | application and examples. 2014. Wiley & Sons. |
| | Book. |
| Poetz 2012 | Marian Poetz, Martin Schreier. The value of |
| | crowdsourcing: Can users really compete with |
| | professionals in generating new product ideas? |
| | Journal of Product Innovation Management 29: |
| | 245-256. 2012. |
| Suttapong 2012 | Suttapong, K & Tian Z. Performance Benchmarking |
| | for Building Best Practice in Small and Medium |
| | Enterprises (SMEs). International Journal of |
| | Business and Commerce 1: 10: 46-60. 2012. |
| Reynolds 2000 | Reynolds, P. National Panel Study of U.S. Business |
| | Startups: Background and Methodology. Databases |
| | for the Study of Entrepreneurship, Volume 4, |
| | P 153-227. 2000. |

What is claimed is:

1. A method of creating evidentiary data consisting essentially of the steps:
a. Generating at least three types of data selected from the list consisting of data, SME data, crowd-as-expert data, crowd-as-participant data, and expert data;
b. Assembling in one or more databases, said data in Step (a);
c. Generating one or more types of scores selected from the list consisting of expert score, crowd-as-participant score, and control score;
d. Assembling in said one or more databases, said scores from Step (c); and
e. Assembling in said one or more databases from Step (d), more than two types of alternative investing issuer information selected from the list consisting of issuer event tag, crowd event tag, segment of an issuers business, milestone, data useful in evidentiary support, and SIC code.

2. Evidentiary data for use in business valuation, wherein the evidentiary data is created by industry participants taking the steps consisting essentially of:
a. Generating at least three types of data selected from the list consisting of data, SME data, crowd-as-expert data, crowd-as-participant data, and expert data;
b. Assembling in one or more databases, said data in Step (a);
c. Generating one or more types of scores selected from the list consisting of expert score, crowd-as-participant score, and control score;
d. Assembling in said one or more databases, said scores from Step (c); and
e. Assembling in said one or more databases from Step (d), more than two types of alternative investing issuer information selected from the list consisting of issuer event tag, crowd event tag, segment of an issuers business, milestone, data useful in evidentiary support, and SIC code.

3. Evidentiary data for use in business valuation, the evidentiary data comprising:
a. Data assembled in one or more databases;
b. Said one or more databases in (a) containing fields populated by at least three selections of compiled information selected from the group consisting of data, SME data, crowd-as-expert data, expert data, expert score, crowd-as-participant score, and control score;
c. Said selections of compiled information from (b) containing more than two types of information selected from the group consisting of one or more issuer event tags, one or more segments of an issuer's business, one or more crowd event tags, one or more milestones, data useful in evidentiary support, and one or more SIC codes; and
d. Said selections of compiled information from (c), wherein said selections derive from industry participants interacting with transactions in securities offered by alternative investing issuers.

4. The use of claim 1 by one or more industry participants, wherein said participants make use of evidence suitable for generating a conclusion of value for one or more privately held businesses for a purpose selected from the group consisting of transaction, litigation, regulatory, and tax.

5. The evidence for use in business valuation of claim 2, the creation of which further comprises:
a. Means for assembling database fields of at least three selections of compiled information selected from the group consisting of data, SME data, crowd-as-expert data, expert data, expert score, crowd-as-participant score, and control score;
b. Means for assembling database fields of selections of compiled information from (a) containing more than two types of information selected from the group consisting of one or more issuer event tags, one or more segments of an issuer's business, one or more crowd event tags, one or more milestones, data useful in evidentiary support, and one or more SIC codes; and
c. Means for assembling said database fields of selections of compiled information from (b), wherein said selections derive from industry participants interacting with transactions in securities offered by alternative investing issuers.

6. The evidentiary data for use in business valuation of claim 3, wherein one or more kits for valuing a privately held small business comprises:
a. Means for one or more industry participants accessing one or more databases containing evidentiary data; and
b. Means for one or more industry participants accessing one or more reports containing evidentiary data.
